(19) United States
(12) Patent Application Publication
(10) Pub. No.: US 2008/0244729 A1
(43) Pub. Date: Oct. 2, 2008

(54) INFORMATION PROCESSING APPARATUS, INFORMATION PROCESSING METHOD AND COMPUTER READABLE MEDIUM

(75) Inventor: Kazuaki OZAWA, Tokyo (JP)

Correspondence Address: SUGHRUE-265550, 2100 PENNSYLVANIA AVE. NW, WASHINGTON, DC, 20037-3213, US

(73) Assignee: FUJI XEROX CO.,LTD, Tokyo (JP)

(21) Appl. No.: 11/853,308

(22) Filed: Sep. 11, 2007

(30) Foreign Application Priority Data
Mar. 30, 2007 (JP) 2007-093872

(51) Int. Cl. H04L 9/32

(52) U.S. Cl. 726/16

(57) ABSTRACT

An information processing apparatus includes a communication section, a control section, an operating section, a storage section. The control section sends identification information of a first user to an external apparatus connected through the communication section. The operating section allows the first user to request at least one function. The storage section stores approver authentication information of an approver previously registered. When the communication section fails to receive, from the external apparatus, information indicating what function the first user is permitted to request as a response to the identification information of the first user, the control section authenticates a second user based on the stored approver authentication information. The control section executes the function requested by the first user when an authentication result shows that the second user is the approver.

### CROSS-REFERENCE TO RELATED APPLICATIONS

This application is based on and claims priority under 35 USC 119 from Japanese Patent Application No. 2007-093872 filed Mar. 30, 2007.

### BACKGROUND

1. Technical Field

This invention relates to an information processing apparatus, an information processing method and a computer readable medium.

2. Related Arts

An information processing apparatus called a multifunction processing machine including the functions of a scanner, a printer, a copier, etc., integrally is available. In recent years, an authentication apparatus has been connected to such a multifunction processing machine through a network for suppressing execution of processing based on command operation of the user until the user is authenticated.

### SUMMARY

According to an aspect of the invention, an information processing apparatus includes a communication section, a control section, an operating section, a storage section. The control section sends identification information of a first user to an external apparatus connected through the communication section. The operating section allows the first user to request at least one function. The storage section stores approver authentication information of an approver previously registered. When the communication section fails to receive, from the external apparatus, information indicating what function the first user is permitted to request as a response to the identification information of the first user, the control section authenticates a second user based on the stored approver authentication information. The control section executes the function requested by the first user when an authentication result shows that the second user is the approver.

### BRIEF DESCRIPTION OF THE DRAWINGS

Exemplary embodiments of the present invention will be described in detail based on the following figures, wherein:

FIG. 1 is a block diagram to show a configuration example and a connection example of an information processing apparatus according to an exemplary embodiment of the invention;

FIG. 2 is a schematic representation to show an example of approver authentication information retained by the information processing apparatus according to the exemplary embodiment of the invention;

FIG. 3 is a schematic representation to show an example of user authentication information retained by an authentication server connected to the information processing apparatus according to the exemplary embodiment of the invention;

FIG. 4 is a flowchart to show an example of the usual operation of the information processing apparatus according to the exemplary embodiment of the invention;

FIG. 5 is a flowchart to show an operation example when the information processing apparatus according to the exemplary embodiment of the invention does not obtain authentication information;

FIG. 6 is a schematic representation to show an example of a screen displayed when the information processing apparatus according to the exemplary embodiment of the invention makes a request for approval;

FIG. 7 is a schematic representation to show a setup example of operation when authentication information is not obtained in the information processing apparatus according to the exemplary embodiment of the invention makes a request for approval; and

FIG. 8 is a schematic representation to show a content example of an approval result database retaining the result of past approval in the information processing apparatus according to the exemplary embodiment of the invention.

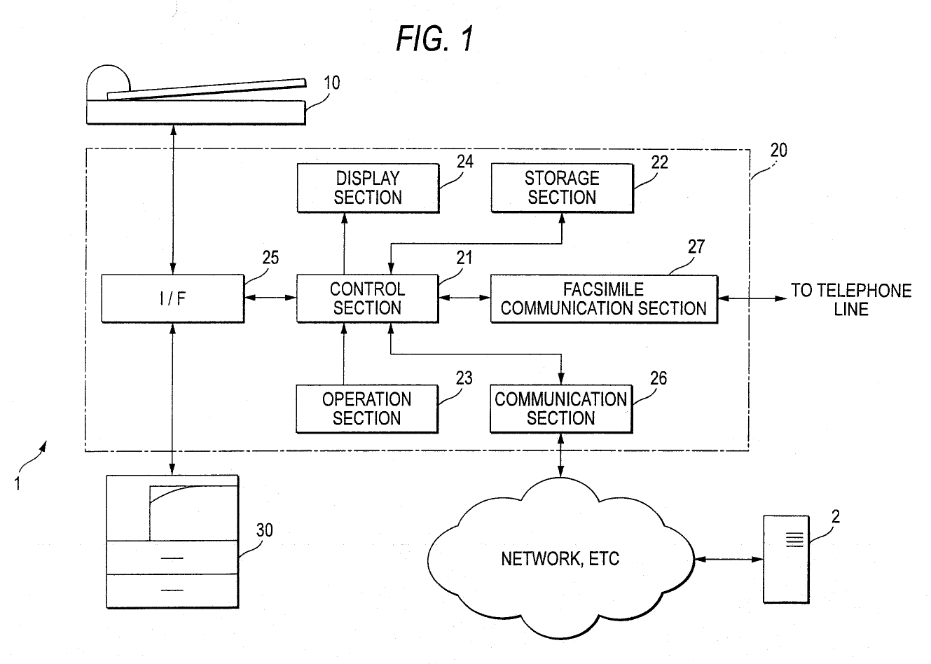

### DETAILED DESCRIPTION

Referring now to the accompanying drawings, an exemplary embodiment of the invention will be described. An information processing apparatus 1 according to the exemplary embodiment is a multifunction processing machine implementing the functions of a scanner, a printer, a copier, etc., integrally, for example, and includes a scanner section 10, a controller section 20, and a printer section 30. The controller section 20 includes a control section 21, a storage section 22, an operation section 23, a display section 24, an interface section 25, a communication section 26, and a facsimile communication section 27. The information processing apparatus 1 further is connected to an authentication server 2 through communication such as a network. Here, the information processing apparatus 1 is a multifunction processing machine by way of example, but may be any if it is generally a computer-controlled machine.

The scanner section 10 is a flat bed scanner and optically reads an original placed on a read plane in accordance with a scan command input from the controller section 20. The scanner section 10 outputs information of the read image to the controller section 20.

The control section 21 of the controller section 20 is a microprocessor, etc., and operates in accordance with a program stored in the storage section 22. When receiving command operation of the user, the control section 21 retains the description of the command operation in the storage section 22. It authenticates the user performing the command operation. When the user is authenticated, the control section 21 executes processing in accordance with the retained description of the command operation in the storage section 22.

For example, when accepting a scan command from the user, the control section 21 stores the command in the storage section 22 and authenticates the user. If authentication of the user results in success, the control section 21 reads the stored command and instructs the scanner section 10 to read an original in accordance with the command. The controller section 20 (control section 21) accepts information of the image read in accordance with the command and transmits the image information to the destination specified by the user.

The authentication can be conducted by a method of requesting the user to enter authentication information of the user name, etc., and making a comparison between the authentication information and the information retained in an authentication server 2, etc. The authentication information may be accepted according to a method of placing an IC card in an IC card reader, etc., by way of example.

When acquisition of external authentication information results in failure as communications with the authentication server 2 cannot be conducted, for example, the control section 21 prompts a preset approver to enter authentication information of the approver and when the authentication information of the approver is entered, the control section 21 makes a comparison between the entered authentication information of the approver and approver authentication information previously stored in the storage section 22. When a predetermined condition is satisfied as they match, the control section 21 executes processing in accordance with the retained description of the command operation. The processing of the control section 21 is described later in detail.

The storage section 22 includes RAM (random access memory), a hard disk, etc., for example. The program executed by the control section 21 is stored in the storage section 22. The program may be received as an external data signal through a communication line of a network, etc., or may be provided in a state in which it is stored in a computer-readable record medium such as a DVD-ROM and be stored in the storage section 22, for example.

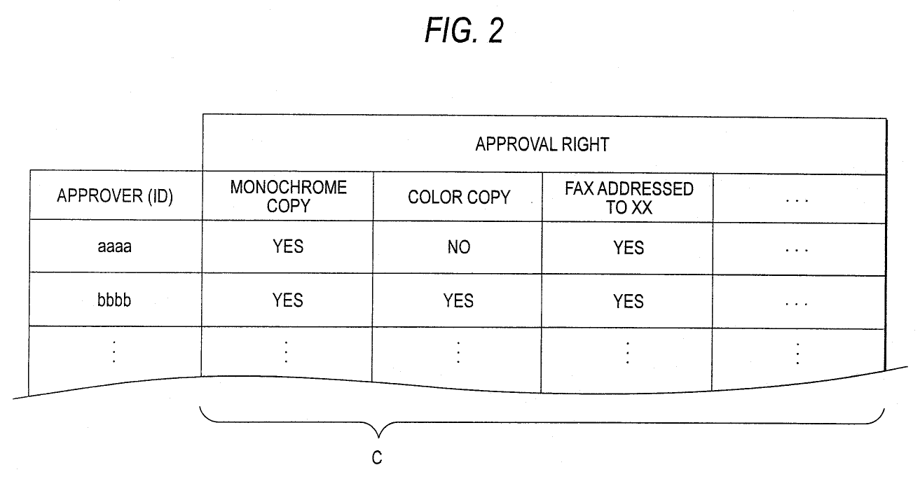

The storage section 22 also operates as work memory of the control section 21. Further, the storage section 22 of the exemplary embodiment previously retains authentication information of the approver (approver authentication information). The approver authentication information provides the identifier (ID) assigned to each approver and information (C) to determine the description of operation that can be approved by the approver in association with each other, for example, as shown in FIG. 2.

The description of operation that can be approved may be information to determine the type of function that can be provided by the information processing apparatus 1 as a multifunction processing machine, such as “scan,” “print,” etc., for example. It may be a facsimile destination, etc. To set a facsimile destination, if the destination is specified as the transmission destination, facsimile transmission can be approved; if any other transmission destination than the destination is specified, facsimile transmission cannot be approved.

The operation section 23 is a ten-key numeric pad, a touch panel put on the display section 24, or the like. The description of operation on the operation section 23 is output to the control section 21. The display section 24 is a liquid crystal panel, etc., for example, for displaying information in accordance with a command input from the control section 21.

The interface section 25 is connected to the scanner section 10 and the printer section 30 for transmitting and receiving image information, a command, etc., to and from the scanner section 10 and the printer section 30. The communication section 26 is a network card, for example, and transmits and receives information to and from the authentication server 2, etc., through the communication line of the network, etc. The facsimile communication section 27 is connected to a telephone network and calls the specified destination in accordance with a command input from the control section 21. When the called party gets the incoming call, the facsimile communication section 27 transmits image information to the called party by facsimile. The printer section 30 forms an image on a medium of paper, etc., based on image information input from the control section 21.

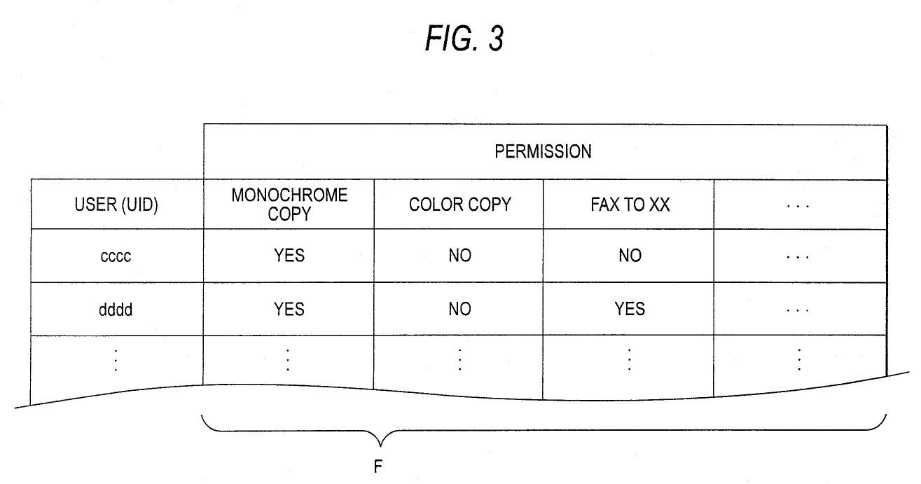

The authentication server 2 retains the authentication information of the user. The authentication information provides identification information for identifying the user (UID) and information (F) to represent the function of the multifunction processing machine that can be used by the user in association with each other, as shown in FIG. 3. Upon reception of input of the identification information of the user from the information processing apparatus 1 through the communication line of the network, etc., the authentication server 2 transmits the information to represent the function of the multifunction processing machine that can be used by the user, associated with the identification information to the information processing apparatus 1.

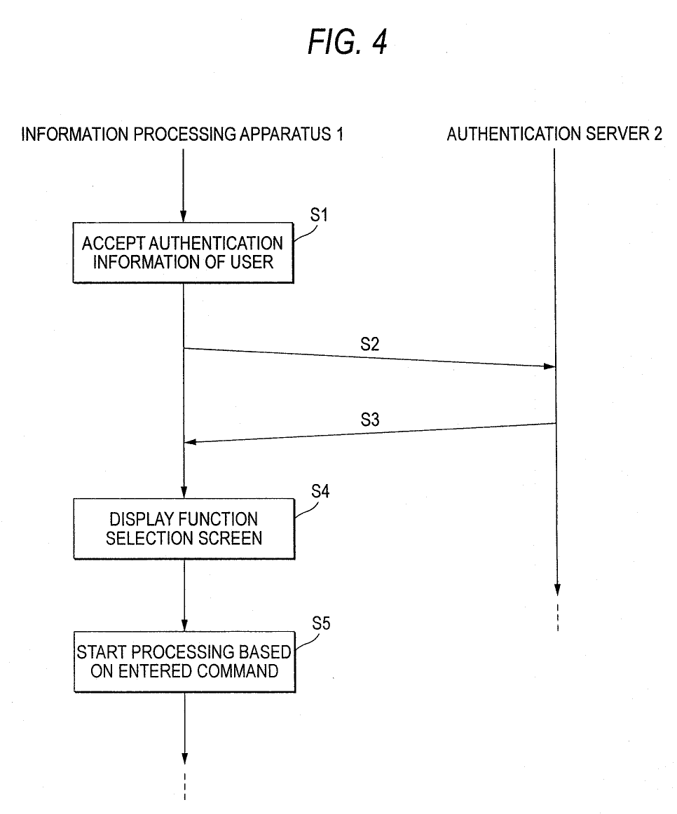

The information processing apparatus 1 of the exemplary embodiment has the described configuration and operates as follows: As shown in FIG. 4, when the user enters the authentication information of the user by bringing an IC card close to an IC card reader (not shown), etc., of the information processing apparatus 1 (S1), the information processing apparatus 1 transmits the authentication information of the user to the authentication server 2 (S2). Upon reception of the authentication information, the authentication server 2 reads information associated with the received authentication information (for example, information to represent the function that can be used by the user) and transmits the read information to the information processing apparatus 1 (S3). If information associated with the received authentication information does not exist in the authentication server 2, the authentication server 2 may transmit information indicating the fact.

The information processing apparatus 1 displays a screen for permitting the user to select the function represented by the received information (S4). For example, if the authentication server 2 transmits information indicating that the functions of monochrome copy and print can be used, the information processing apparatus 1 displays a screen for prompting the user to select either of monochrome copy and print on the display section 24. The user selects either function out of the screen and enters a processing command operation. The information processing apparatus 1 executes processing in accordance with the description of the command operation (S5).

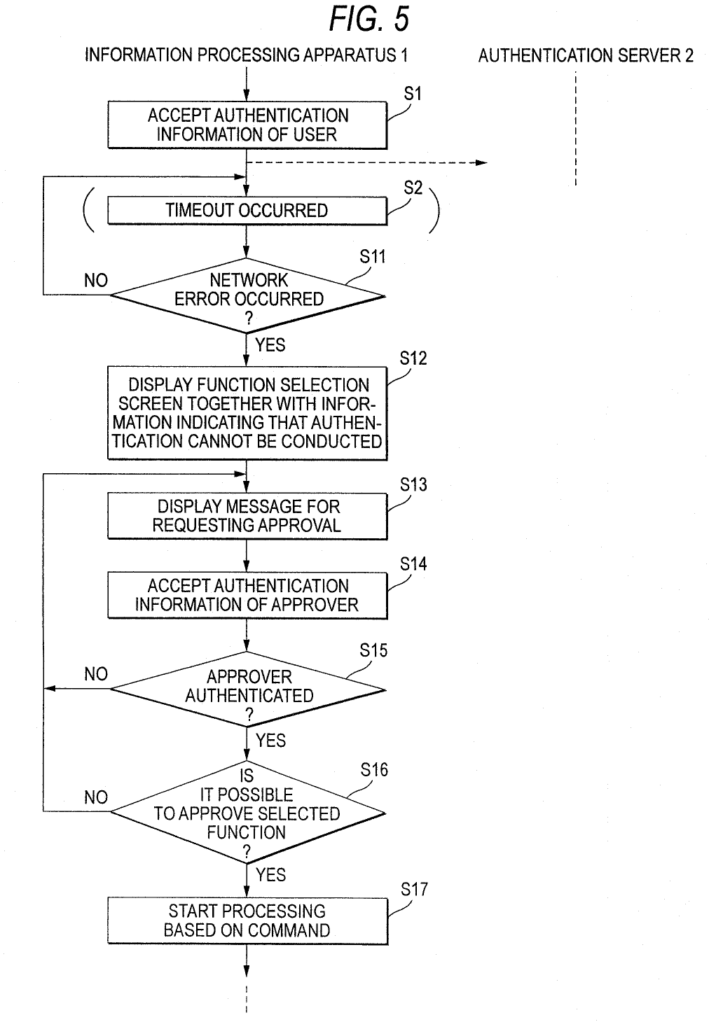

On the other hand, when communications between the information processing apparatus 1 and the authentication server 2 are impossible as a bride on the network fails, for example, if the user enters the authentication information of the user by bringing an IC card close to the IC card reader (not shown), etc., of the information processing apparatus 1 (S1) and the information processing apparatus 1 tries to transmit the authentication information of the user to the authentication server 2 (S2), a network error such as a timeout occurs and the authentication information cannot be transmitted, as shown in FIG. 5.

Then, the information processing apparatus 1 checks whether or not a network error occurs (S11). When a network error occurs, the information processing apparatus 1 displays a screen for the user to select any of the functions of the multifunction processing machine together with information indicating that communications with the authentication server 2 cannot be conducted (S12).

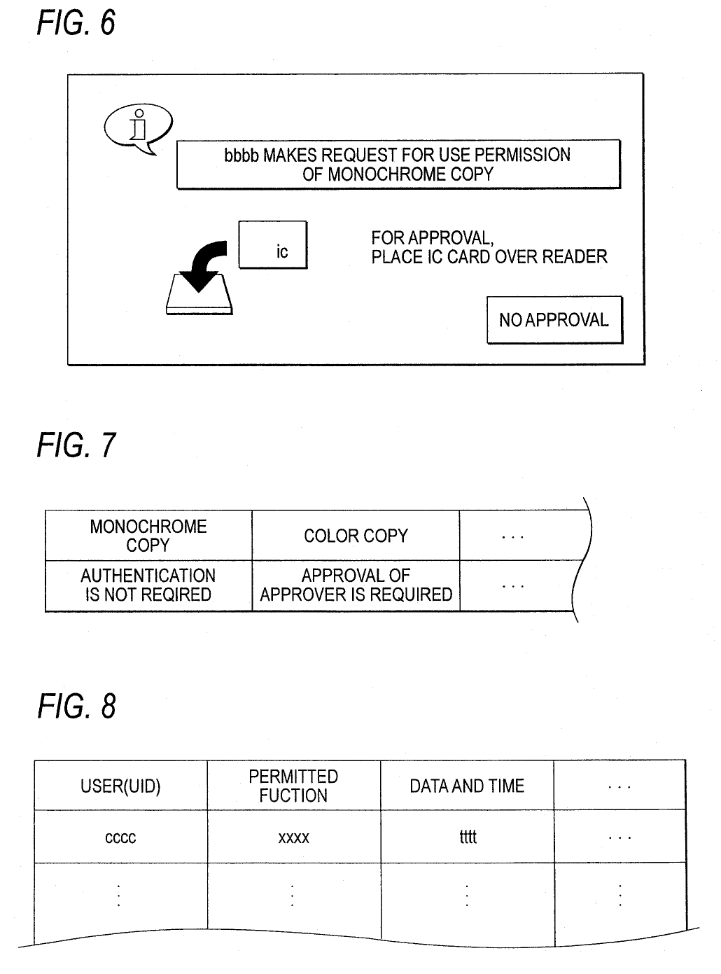

When the user selects any function, the information processing apparatus 1 produces display for requesting the predetermined approver to give approval (S13) as shown in FIG. 6. In the display, the function selected by the user is displayed. The display enables the approver to enter intention of no approval. When the approver does not determine that the function selected by the user should be executed, the approver performs operation of entering “no approval.” In this case, the information processing apparatus 1 terminates the processing.

Further, for example, a list of approvers stored in the storage section 22 may be displayed for requesting the user to get approval of any approver. If the function of the multifunction processing machine that can be approved by each approver is associated with the approver authentication information stored in the storage section 22, the approvers that can approve the selected function on the screen displayed at step S12 by the user may be selected and a list of the selected approvers may be displayed.

When the approver enters the authentication information of the approver (S14: Also in this case, the approver may enter the authentication information by bringing an IC card close to the IC card reader (not shown), etc.,), the information processing apparatus 1 references the approver authentication information stored in the storage section 22 and authenticates the approver (S15). It determines whether or not the function specified by the user can be approved (S16).

When the information processing apparatus 1 does not authenticate the approver or does not determine that the function specified by the user can be approved, the information processing apparatus 1 displays the fact and terminates the processing. On the other hand, when the information processing apparatus 1 authenticates the approver and determines that the function specified by the user can be approved, the information processing apparatus 1 executes processing in accordance with the description of the command operation performed by the user (S17).

Here, at step S13, the approver is requested to give approval independently of the function selected by the user. However, the exemplary embodiment is not limited to the mode. For example, a method of action to be taken when the authentication information of the user cannot be accessed as communications with the authentication server 2 are impossible, etc., may be stored in the storage section 22 in association with each function that can be selected by the user as shown in FIG. 7. Here, it is assumed that as the action method, “authentication is not required,” “approval of approver is required,” “use prohibited,” etc., is associated with each function. If the information of “approval of approver is required” is associated with the user-selected function, the step S13 and the later shown in FIG. 5 may be executed. If the information of “authentication is not required” is associated with the user-selected function, the information processing apparatus 1 may go to step S17 and may execute processing in accordance with the description of the command operation performed by the user.

Further, if the information of “use prohibited” is associated with the user-selected function, the information processing apparatus 1 displays a message to the effect that use of the function is prohibited, and terminates the processing.

When the information processing apparatus 1 authenticates the approver and determines that the function specified by the user can be approved at steps S15 and 16 in FIG. 5, the information processing apparatus 1 may cache the result of the approval for later use.

For example, in this case, information for determining the user performing approval operation, information representing the function whose use permission is approved for the user, and information of the approval date and time are associated with each other for storage as an approval result database (FIG. 8). When the user performs function selection operation at step S12, the information processing apparatus 1 references the approval result database and checks whether or not execution of the selected function was approved for the user in the past. If a record of approving execution of the selected function in the past for the user selecting the function exists in the approval result database, the information processing apparatus 1 may approve execution of the function by the user according to the record, may go to step S17, and may execute processing in accordance with the description of the command operation performed by the user. The information processing apparatus 1 may reference the approval result database every predetermined timing (for example, on a regular basis) and may delete the result of the approval associated with the information representing the approval given in the past exceeding a predetermined time period from the reference date and time from the approval result database. For example, the record after the expiration of one day or more since the approval time point may be deleted from the approval result database.

Further, when the information processing apparatus 1 authenticates the approver and determines that the function specified by the user can be approved (namely, approval is given) at steps S15 and 16, the information processing apparatus 1 may store the date and time, identification information of the user getting approval of use, identification information of the approver, and the processing description (selected function, etc.,) in the storage section 22, etc., as a log. The log may be stored in an external log storage server through the network rather than the storage section 22.

The information processing apparatus 1 may store a similar log if authentication is conducted by the authentication server 2. The information processing apparatus 1 may make recorded processing description different between a log recorded at the authentication time in the authentication server 2 and a log recorded at the approval time. For example, the log recorded at the approval time may contain not only the selected function, but also option (color, monochrome, paper size, etc.,) information, processed image information, etc., in addition to the log recorded at the authentication time in the authentication server 2.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a communication section;
a control section that sends identification information of a first user to an external apparatus connected through the communication section;
an operating section that allows the first user to request at least one function; and
a storage section that stores approver authentication information of an approver previously registered,
wherein
when the communication section fails to receive, from the external apparatus, information indicating what function the first user is permitted to request as a response to the identification information of the first user, the control section authenticates a second user based on the stored approver authentication information, and
the control section executes the function requested by the first user when an authentication result shows that the second user is the approver.

2. A computer readable medium storing a program causing a computer to execute information processing, the information processing comprising:
sending identification information of a first user to an external apparatus;
allowing the first user to request at least one function;
authenticating a second user based on approver authentication information stored in a storage device of the computer when the computer fails to receive, from the external apparatus, information indicating what function the first user is permitted to request as a response to the identification information of the first user; and
executing the function requested by the first user when an authentication result shows that the second user is the approver.

3. The information processing apparatus of claim 1:
wherein the control section requests identification information of the second user from the second user, and authenticates the second user based on the identification information of the second user and the approver authentication information.

4. The information processing apparatus of claim 1:
wherein the approver authentication information includes (1) identification information of the approver, and (2) information indicating a function that the approver is allowed to approve, in association with each other.

5. The information processing apparatus of claim 4:
wherein the control section executes the function requested by the first user when the function requested by the first user is the function that the approver is allowed to approve.

6. The information processing apparatus of claim 4:
wherein the information indicating what function the first user is permitted to request includes (1) information indicating as to whether or not the first user is permitted to request a monochrome copying function, (2) information indicating as to whether or not the first user is permitted to request a color copying function and (3) information indicating as to whether or not the first user is permitted to request a facsimile function.

7. The information processing apparatus of claim 1:
wherein when the communication section fails to communicate with the external apparatus, the control section judges failing to receive the response to the identification information of the first user.
